(19) United States
(12) Patent Application Publication
(10) Pub. No.: US 2023/0122421 A1
(43) Pub. Date: Apr. 20, 2023

(54) EMULSIFICATION DEVICE

(71) Applicant: Merck Patent GmbH, Darmstadt (DE)

(72) Inventors: David Moore, WEINHEIM (DE); Philipp Knoth, PLANKSTADT (DE)

(21) Appl. No.: 17/907,032

(22) PCT Filed: Mar. 29, 2021
(86) PCT No.: PCT/EP2021/058066

§ 371 Date: Sep. 22, 2022

(30) Foreign Application Priority Data
Apr. 1, 2020 (EP) 20167598.0

(51) Int. Cl. B01F 23/41; B01F 23/451

(52) U.S. Cl. CPC B01F 23/4143; B01F 23/4145; B01F 23/451; B01F 23/4105; B01F 2215/0431; B01F 2101/44

(57) ABSTRACT

The disclosure herein relates to a microfluidic emulsification device capable of being injection molded. The device may be used for digital droplet polymerase chain reaction (ddPCR). The emulsification device comprises: (a) a cylindrical outer part (4) with two open ends; (b) a cylindrical inner part (1) with a solid bottom and having a circumference sufficient to allow the inner part to be nested within the outer part of the emulsification device, wherein the inner part and the outer part are capable of sliding freely; (c) at least one groove on an interior surface of the outer part or on an exterior surface of the inner part, the groove having a height greater than a gap between the outer part and the inner part when nested; (d) at least one hole (3) in the inner part adjacent to the solid bottom; (e) a radial distribution channel (2) on the interior surface of the outer part or on the exterior surface of the inner part; and (f) a radial nozzle channel at the base of the interior surface of the outer part or at the base of the exterior surface of the inner part.

### RELEVANT FIELD

Embodiments disclosed herein relate to microfluidic droplet emulsification. More specifically, embodiments of the technology relate to an injection molded emulsification device.

### BACKGROUND

Microfluidic droplet emulsification is a technique used to create oil or water droplets with a diameter ranging from 1-1000 μm. Microfluidic droplet emulsification is used in fields such as fragrance encapsulation, single-cell sequencing, and droplet digital polymerase chain reaction (ddPCR). Common in these fields is the desire for better control in creation of monodisperse droplets.

Microfluidic droplet emulsifiers can be divided into two common types. One type generates droplets by shear flow of a continuous phase, for example, low flow-focusing and T-junction devices. Droplet formation ceases and jetting begins if the shear stress of the continuous phase is too high or the inertial forces of the droplet phase are too high. Droplet size is also inversely dependent on flow rates, as described in Utada et al. (2007) Phys. Rev. Lett. 99, 094502, which is hereby incorporated by reference in its entirety. Therefore, using shear flow techniques to generate droplets requires stringent control over the flow rate to controllably form monodisperse droplets.

Another type of microfluidic droplet emulsifier induces a Rayleigh-Plateau instability resulting from two opposing Laplace pressures at a drop forming outlet. The first Laplace pressure is positive and is that of the budding droplet and the second pressure is negative and is that of the neck at the outlet. The radius of the neck is fixed by the specific geometry of the channel, as described in Eggersdorfer et al. (2018) PNAS, 115 (38): 9479-9484, which is hereby incorporated by reference in its entirety. Once the sum of these pressures is less than zero, such as when the droplet radius exceeds a critical value of 2.0 times the outlet height, the droplet spontaneously forms. In contrast to shear flow driven devices, these devices are not sensitive to variation in flow rate.

Rayleigh-Plateau emulsifiers include edge emulsification, step emulsification, and grooved step emulsification. Edge emulsification is achieved by creating a channel of pseudo-infinite width, but of finite height and length, such that the ratio between length and height should be greater than 20 (i.e., l/h>20) (See, patent number NL2002862 and van Dijke et al., Lab Chip, 2009, 9, 2824-2830, each of which is hereby incorporated by reference in its entirety).

Step emulsification, also known as microchannel emulsification, is similar to edge emulsification, except that the wide channel is discretized into individual channels of width greater than or equal to the height (See, Ofner et al., Macromol. Chem. Phys. 2017, 218, 1600472; Sugiura et al., Journal of Colloid and Interface Science 227, 95-103 (2000); and Sugiura et al. Langmuir 2002, 18, 5708-5712, each of which is hereby incorporated by reference in its entirety). Fluidic resistance in discrete channels reduces fluctuations in pressure and results in more robust droplet creation than in edge emulsification.

Grooved step emulsification is a hybrid of step and edge emulsification techniques as described in Opalski et al. Lab Chip, 2019, 19, 1183, which is hereby incorporated by reference in its entirety. Discrete channels exist as grooves in an infinitely wide edge channel resulting in nearly the same robustness of step emulsification with slightly higher throughput due to the lower fluidic resistance.

Due to the parallelizable design, step emulsification is commonly used for passive droplet generation, including technologies such as centrifugation (See, Shin et al., Sensors & Actuators: B. Chemical 301 (2019) 1277164 and Schuler et al. Lab Chip, 2015, 15, 2759). Additionally, the lack of dependency on flowrates means a tightly sealed channel is not required (See, Nie et al. Anal. Chem. 2019, 91, 1779-1784), which allows for the assembly of devices without chemically sealing the parts together. Typically, microfluidic devices in the prior art have two sheets which must be sealed together in order to create the channels.

Devices for use in step emulsification are generally fabricated from silicon, poly(dimethylsiloxane), polycarbonate, and glass.

Step emulsification has not yet been adapted to a mass-producible design, in part, due to the previously mentioned criteria of having a channel of high aspect ratio (l/h>20). Further, for mass production, the tool for molding the device used for step emulsification should be formed using conventional milling and lathing techniques and made of common materials. The device should also be compatible with common laboratory equipment, such as centrifuges, thermal cyclers, spectrophotometers, and liquid handlers.

High aspect ratios (length (l)/height (h)>20) are not achievable with injection molding of a single part. Additionally, high aspect ratios are difficult to achieve using subtractive techniques like etching and sandblasting. Other common approaches used for previous devices like soft-lithographic techniques or wet etching techniques are not scalable, and techniques for bonding parts used in previous devices are not suitable for mass production. Therefore, an emulsification device with two parts, each made by injection molding and assembled without bonding, represents an inventive advance in the art.

### SUMMARY

The shortcomings of the prior art are overcome by embodiments described herein, which include some embodiments disclosed herein providing an injection molded emulsification device with an inner part nested within an outer part without bonding. When nested, the emulsification device is compatible with a single tube or a multi-well array for droplet production.

Some embodiments described herein provide an emulsification device comprising: a cylindrical outer part with two open ends; a cylindrical inner part with a bottom and having a circumference sufficient to allow the inner part to be nested within the outer part of the emulsification device, wherein the inner part and the outer part are capable of sliding freely; at least one groove on an interior surface of the outer part or on an exterior surface of the inner part, the groove having a height greater than a gap between the outer part and the inner part when nested; at least one hole in the inner part adjacent to the bottom; and a radial distribution channel on the interior surface of the outer part or on the exterior surface of the inner part; and a radial nozzle channel at the base of the interior surface of the outer part or at the base of the exterior surface of the inner part.

In some embodiments, the emulsification device is injection molded. In some embodiments, the emulsification device is inserted into a container for use. In some embodiments, the container is a polymerase chain reaction (PCR) tube. In some embodiments, the container is a plate with a plurality of wells. For example, the plate may have between 1 to 40 wells, 20 to 60 wells, 40 to 80 wells, or 60 to 100 wells. In some embodiments, the plate has more than 100 wells.

In some embodiments, the at least one groove is on an interior surface of the outer part. Alternatively, the at least one groove may be on an exterior surface of the inner part. In some embodiments, the at least one groove is closed off to form a channel when the inner part is nested within the outer part. In some embodiments, the at least one groove is vertical when the emulsification device is in use. In some embodiments, the at least one groove is horizontal while the device is in use. In some embodiments, the at least one groove has a length of about 1 mm, a depth selected from the range of 0.01 mm to 0.5 mm, and a width selected from the range of 0.04 mm to 2 mm. In some embodiments, the depth is about 0.025 mm. In some embodiments, the width is about 0.1 mm.

In some embodiments, the radius of the inner part and the radius of the outer part differ by less than the depth of the at least one groove. In some embodiments, the radial distribution channel is about 0.5 mm above the bottom of the inner part. In some embodiments, the radial distribution channel has a depth between about 10 μm and about 0.2 mm. In some embodiments, the radial distribution channel has a depth of about 0.2 mm. In some embodiments, the radial distribution channel has a depth of about 10 μm. In some embodiments, the radial distribution channel has a depth of 10 μm. In some embodiments, the radial distribution channel has a depth of less than 10 μm. In some embodiments, the radial distribution channel has a depth within a range selected from the group consisting of: about 10 μm to about 50 μm, about 40 μm to about 80 μm, about 70 μm to about 110 μm, about 100 μm to about 140 μm, about 130 μm to about 170 μm, and about 160 μm to about 200 μm. In some embodiments, the radial distribution channel has a depth selected from the group consisting of: 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, and 199 μm.

In some embodiments, the radial distribution channel has a width of about 10 μm. In some embodiments, the radial distribution channel has a width of 10 μm. In some embodiments, the radial distribution channel has a width of less than 10 μm. In some embodiments, the radial distribution channel has a width within a range selected from the group consisting of: about 10 μm to about 50 μm, about 40 μm to about 80 μm, about 70 μm to about 110 μm, about 100 μm to about 140 μm, about 130 μm to about 170 μm, and about 160 μm to about 200 μm. In some embodiments, the radial distribution channel has a width selected from the group consisting of: 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, and 199 μm.

In some embodiments, the radial nozzle channel is the same depth as the at least one groove. In some embodiments, the at least one groove has a 20:1 ratio of length-to-depth. In some embodiments, the bottom of the inner part is solid. In some embodiments, a solid bottom to capture air bubbles during droplet formation. In some embodiments, the bottom of the inner part comprises a conical or a cup-shaped protrusion. In some embodiments, the bottom of the inner part comprises a cylinder-shaped protrusion. In some embodiments the cylinder-shaped or the conical protrusion comprises an opening. In some embodiments, the opening of the bottom of the inner part displaces air bubbles to result in a greater number of droplets during droplet formation. In some embodiments, the at least one hole is a slit.

Some embodiments described herein provide a plurality of the emulsification device arranged in an array. In some embodiments, the array is a plate with more than one well. In some embodiments, the plate has at least 96 wells. In some embodiments, the plate has more than 96 wells.

Some embodiments described herein a method of producing droplets for droplet digital polymerase chain reaction (ddPCR), the method comprising: inserting the emulsification device described herein into a polymerase chain reaction (PCR) tube or a multi-well plate containing a continuous phase; pipetting a droplet phase into the reservoir of the inner part, whereby the droplet phrase is distributed to an interface between the inner part and the outer part through the holes of the inner part; thereby emitting the phase as droplets from the outer part into the PCR tube.

### BRIEF DESCRIPTION OF THE DRAWINGS

FIG. 1 provides some embodiments of an assembly of the emulsification device.

FIG. 2A provides a bottom view of some embodiments of the outer part. FIG. 2B provides a side view of some embodiments of the outer part.

FIG. 3A, FIG. 3B, and FIG. 3C provide some embodiments of the inner part.

The appended drawings illustrate some embodiments of the disclosure herein and are therefore not to be considered limiting in scope, for the invention may admit to other equally effective embodiments. It is to be understood that elements and features of any embodiment may be found in other embodiments without further recitation and that, where possible, identical reference numerals have been used to indicate comparable elements that are common to the figures.

### DETAILED DESCRIPTION

The disclosure herein describes some embodiments of an assembly of two cylindrical parts, an inner part nested within an outer part, to form an emulsification device, which can be injection molded in mass production. In some embodiments, the emulsification device has an unsealed construction between the inner part and the outer part. For example, no adhesives or welding is used to assemble the emulsification device.

In some embodiments, the nested inner part and outer part solve design shortcomings of previous emulsification devices. For example, the high aspect ratios required in many of the devices in the prior art cannot be directly fabricated into a mass-producible part. In contrast, in some embodiments, the emulsification device has no integrated equipment, such as pumps, fluidic controls, or robotics. Alternatively, in some embodiments, the emulsification device is driven by a syringe pump. In some embodiments, the emulsification device is disposable.

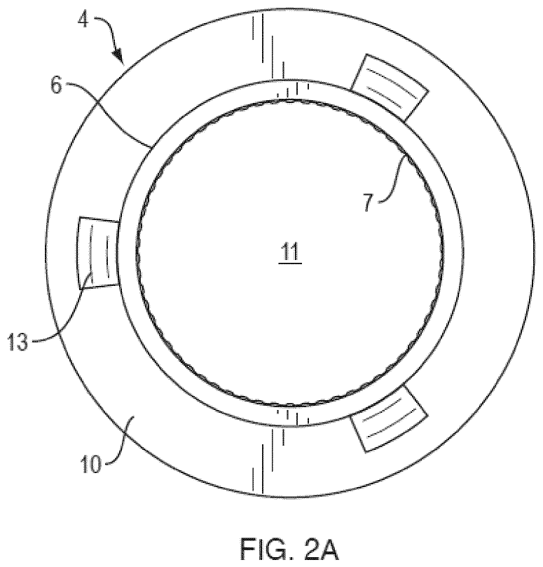

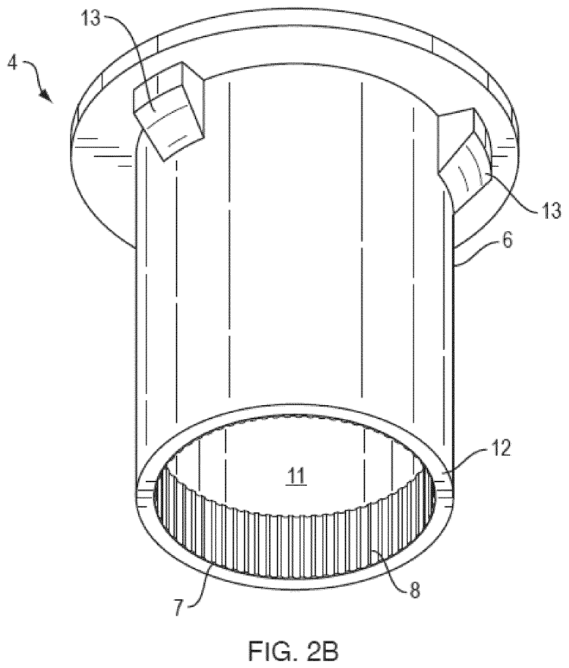

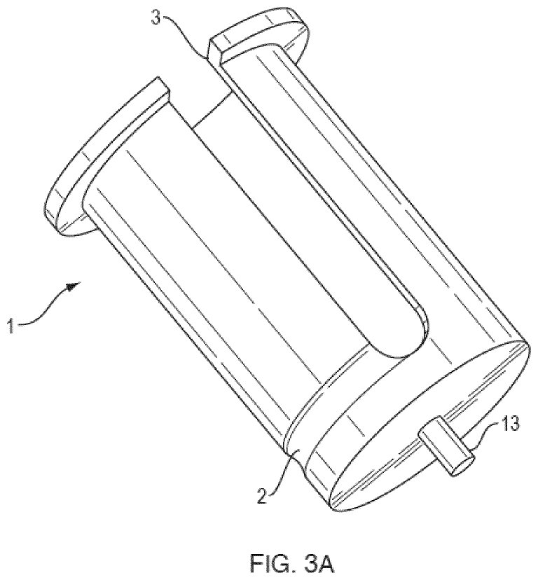

FIG. 2A and FIG. 2B are bottom and side views, respectively, of some embodiments of the outer part 4. In some embodiments, the outer part 4 is a cylindrical cup-shaped object with an open bottom 11.

In some embodiments, the outer part comprises at least one vertical groove 8 on the interior surface 7. In some embodiments, the at least one groove 8 is on the exterior of the inner part 1. In some embodiments, a plurality of grooves 8n is on the interior surface 7 of the outer part 4 or on the exterior of the inner part. In some embodiments, each groove 8 has a length of at least 20 times its depth. In some embodiments, each groove 8 is 1 mm long. In some embodiments, the depth of each groove 8 is 0.025 mm and/or the width of each groove 8 is 0.1 mm.

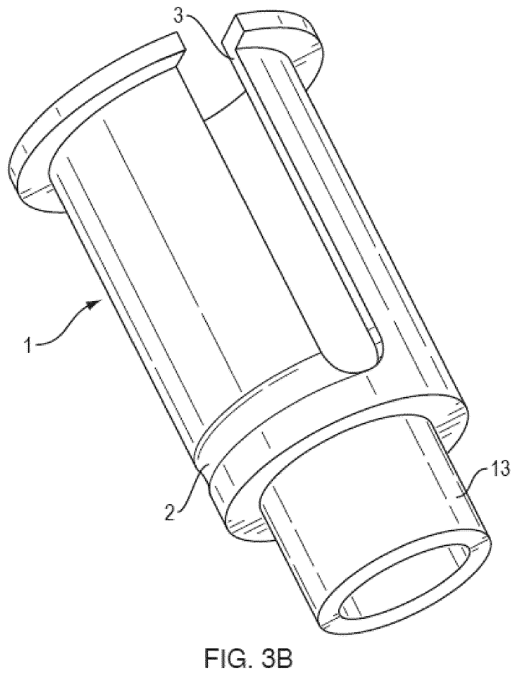

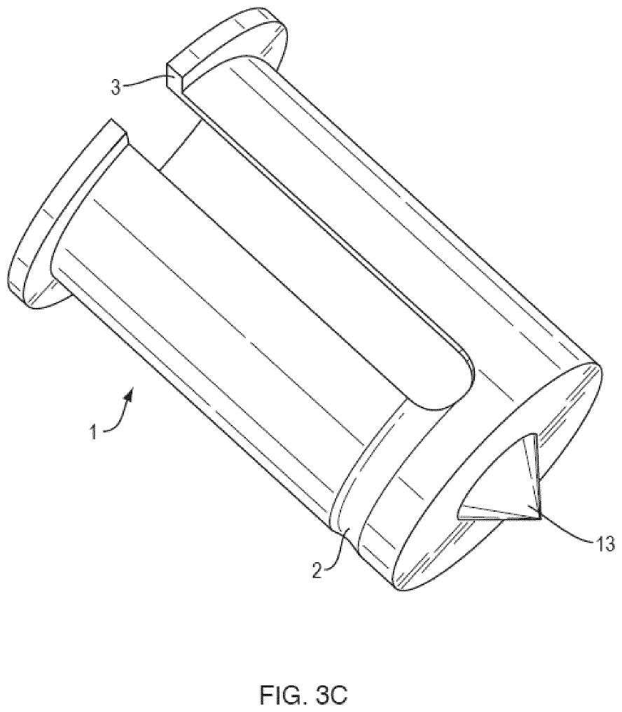

In some embodiments, the inner part 1 is a cup-shaped object with a solid bottom. In some embodiments, the inner part 1 has an opening at the bottom. In some embodiments, the reservoir 9 is the interior of the inner part 1. In some embodiments, the inner part 1 has an outer radius of 0.01 mm less than the inner radius of the outer part 4. In some embodiments, the inner part 1 comprises a hole 3. In some embodiments, the inner part 1 comprises two holes, three holes, four holes, or a plurality of holes 3n adjacent to the bottom. Alternatively, in some embodiments, the hole 3 or the plurality of holes 3n are in the bottom of the inner part 1. In some embodiments, the hole 3 extends vertically to the inner part 1, forming a slit. In some embodiments, the bottom of the inner part 1 has a protrusion 13 that displaces or eliminates air bubbles (e.g. a cylinder or a cone). In some embodiments, the bottom of the inner part 1 has a protrusion 13 that captures air bubbles (e.g. a cup). In some embodiments, the protrusion 13 may have a cylindrical shape (FIG. 3A), a cup shape (FIG. 3B), or a conical shape (FIG. 3C).

In some embodiments, during operation, the droplet phase is added to the reservoir 9 and distributed to the interface between the inner part 1 and the outer part 4 by the through-hole(s) 3n. In some embodiments, the droplet phase is distributed by a radial distribution channel 2 on an exterior of the inner part 1. In some embodiments, the radial distribution channel 2 is 0.2 mm deep and is 0.5 mm above the base of the device. In some embodiments, the spacing of 0.5 mm results in a 20:1 ratio of length-to-height for the distribution channel 2. In some embodiments, the radial distribution channel 2 has a depth of between about 10 μm and about 0.2 mm. In some embodiments, the radial distribution channel 2 has a depth of about 10 μm. In some embodiments, the radial distribution channel 2 has a depth of 10 μm. In some embodiments, the radial distribution channel 2 has a depth of less than 10 μm. In some embodiments, the radial distribution channel 2 has a width of between about 10 μm and about 0.2 mm. In some embodiments, the radial distribution channel 2 has a width of about 10 μm. In some embodiments, the radial distribution channel 2 has a width of 10 μm. In some embodiments, the radial distribution channel 2 has a width of less than 10 μm. In some embodiments, a radial groove 12 at the bottom of the interior surface 7 of the outer part 4 provides a step emulsification terrace-type nozzle. In some embodiments, the radial groove 12 is 0.025 mm deep.

In some embodiments, the emulsification device is made of a material having a contact angle of droplet phase in continuous phase of greater than 120°. In some embodiments, a contact angle below 120° would result in the droplet phase wetting the device and not exhibiting Rayleigh-Plateau instabilities. In some embodiments, the emulsification device is made of polypropylene. Polypropylene has a water-in-hexadecane contact angle of about 151° as shown in Ozkan et al. 2017 Surf. Topogr.: Metrol. Prop. 5 024002, which is hereby incorporated by reference in its entirety. The specific wetting, also known as hydrophobic, properties of polypropylene make a simple press-fit seal sufficient to join the inner part and the outer part. In some embodiments, the emulsification device uses an alkane as an oil phase. In some embodiments, the emulsification device takes advantage of the high water-in-alkane contact angle (151°) of polypropylene to exclude the need for novel surfactants or surface treatments, which results in cost-saving during manufacturing. In some embodiments, emulsification device is made of polycarbonate. Polycarbonate has a water-in-alkane contact angle of 140°. Polycarbonate results in higher affinity injection molded parts compared to polypropylene due to the higher glass transition temperature and lower shrinkage of polycarbonate.

Some embodiments include a plurality of the emulsification device. In some embodiments, the plurality of the emulsification device is arranged in an array. In some embodiments, the plurality of the emulsification device may fit in a multi-well plate, for example, a 24-well, a 48-well, a 96-well, or a 384-well format.

### I. Assembly of Device

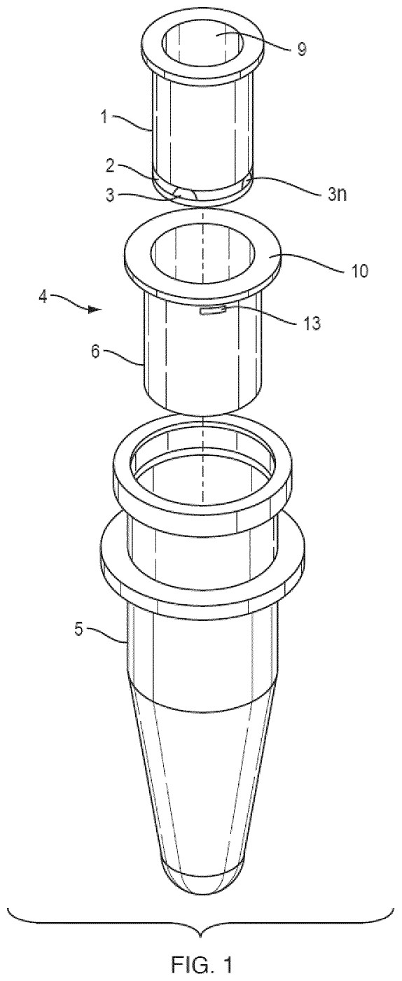

FIG. 1 provides an exploded view of some embodiments of the emulsification device inserted into a PCR tube. In some embodiments, the emulsification device is assembled by nesting the inner part 1 within the outer part 4. In some embodiments, the inner part 1 and the outer part 4 are concentrically nested when the emulsification device is assembled. Alternatively, the inner part 1 and the outer part 4 are internally and tangentially nested when the emulsification device is assembled. In some embodiments, radial symmetry of the inner part 1 and the outer part 4 reduces the need for alignment during assembly of the emulsification device and the need for a clamping force to hold the emulsification device together, in contrast to the emulsification devices shown in the prior art, e.g., Nie et al. Anal. Chem. 2019, 91, 1779-1784, which is hereby incorporated by reference in its entirety. In some embodiments, a press-fit seal is between the inner part 1 and the outer part 4 when the emulsification device is assembled.

In some embodiments, when the emulsification device is assembled, the gap between the inner part 1 and the outer part 4 is less than the height of the groove(s) 8 to achieve robust emulsification.

In some embodiments, the wetting forces resulting from the radial geometry drive the emulsification device to have even spacing between the circumference of the exterior of the inner part 1 and the circumference of the interior surface 7 of the outer part 4. In some embodiments, the inner part 1 and the outer part 4 are manufactured with high accuracy using mold making techniques known in the art, such as lathing, and are suitable for laboratory techniques involving high forces, controlled temperature flux, and/or optical visualization.

Some embodiments include at least one groove 8 fabricated into the interior surface 7 of an outer part 4, which forms a closed channel when the emulsification device is assembled by the inner part 1 being nested within the outer part. Alternatively, in some embodiments, the at least one groove 8 is formed on the exterior of the inner part 1, which forms a closed channel when the emulsification device is assembled by the inner part 1 being nested within the outer part 4. In some embodiments, a plurality of grooves 8n is formed into the interior surface 7 of an outer part 4 or are formed on the exterior of the inner part 1.

In some embodiments, the emulsification device fits within a container for use. For example, the container may be a tube, such as a polymerase chain reaction (PCR) tube 5, or the container may be a multi-well plate. In some embodiments, the inner part 1 is nested within the outer part 4 and inserted into a PCR tube 5 similarly to the inserts found in commercially available DNA isolation kits. In some embodiments, the outer part 4 includes a lip 10, which has a greater outer circumference than the inner circumference of the PCR tube 5. In some embodiments, the lip 10 prevents submersion of the outer part 4 into the PCR tube 5. In some embodiments, the container contains the continuous phase. In some embodiments, the emulsification device is at least partially immersed in the continuous phase leading to the interface between inner part 1 and outer part 4 being wet with the continuous phase.

In some embodiments, the emulsification device comprises microfluidic channels that are sealed by centrifugal force. In some embodiments, the emulsification device comprises an inlet port that opens when the inner part 1 and outer part 4 are at a proper position within the container driven by centrifugal force. In some embodiments, the emulsification device is driven by a syringe pump. In some embodiments, the emulsification device has shallow 5-50 μm deep channels by exploiting electrical discharge machining (EDM) in injection mold tool making.

### II. Methods of Emulsification

In some embodiments, for operation of the emulsification device, the droplet phase is pipetted into the reservoir 9 of the inner part 1, emitted as droplets out of the emulsification device, and allowed to settle in the container. In some embodiments, the emulsification device inserts a water droplet directly into a lower density oil phase. In contrast, the prior art uses a gap of air between the phases. In some embodiments, the method of emulsification using the device herein uses alkanes like hexadecane as an oil instead of fluorinated oils, such as hydrofluoroether (HFE) oil or Fluorinert™ oil (3M).

In some embodiments, the droplet phase may be driven by pressure in the reservoir 9, whether by positive air pressure or by centrifugal force. The volume of droplets formed is the volume of droplet phase pipetted into the inner part. As the droplets form, they displace the continuous phase in the container. In order to prevent overflow, the volume of the space in between the outer part and the container should be equal to or greater than the volume of the reservoir. This space should be occupied with air at the beginning of device operation. In some embodiments, the emulsification device is driven by a syringe pump.

In some embodiments of the method, results are measured by a bulk fluorescence.

### III. Definitions

Unless otherwise defined, all technical and scientific terms used herein have the same meaning as commonly understood by one of ordinary skill in the art to which this technology belongs. Although methods and materials similar or equivalent to those described herein can be used in the practice or testing of the embodiments of the technology disclosed, suitable methods and materials are described below. In case of conflict, the present specification, including definitions, will control. In addition, the materials, methods, and examples are illustrative only and not intended to be limiting. Other features and advantages will be apparent from the following detailed description and the claims.

As used herein, the singular forms “a”, “an,” and “the” include plural unless the context clearly dictates otherwise.

As used herein, the term, “array,” refers to a vessel having a plurality of partitions capable of being used to carry out emulsification.

As used herein, the term, “injection molded,” refers to a manufacturing technique of an item involving injecting the molten phase of a material into a mold forming the item.

### EQUIVALENTS

All ranges for formulations recited herein include ranges therebetween and can be inclusive or exclusive of the endpoints. Optional included ranges are from integer values therebetween (or inclusive of one original endpoint), at the order of magnitude recited or the next smaller order of magnitude. For example, if the lower range value is 0.2, optional included endpoints can be 0.3, 0.4, . . . 1.1, 1.2, and the like, as well as 1, 2, 3 and the like; if the higher range is 8, optional included endpoints can be 7, 6, and the like, as well as 7.9, 7.8, and the like. One-sided boundaries, such as 3 or more, similarly include consistent boundaries (or ranges) starting at integer values at the recited order of magnitude or one lower. For example, 3 or more includes 4, or 3.1 or more.

Reference throughout this specification to “one embodiment,” “certain embodiments,” “one or more embodiments,” “some embodiments,” or “an embodiment” indicates that a feature, structure, material, or characteristic described is included some embodiments of the disclosure. Therefore, the appearances of the phrases such as “in one or more embodiments,” “in certain embodiments,” “in one embodiment,” “some embodiments,” or “in an embodiment” throughout this specification are not necessarily referring to the same embodiment.

Publications of patent applications and patents and other non-patent references cited in this specification are herein incorporated by reference in their entirety in the entire portion cited as if each individual publication or reference were specifically and individually indicated to be incorporated by reference herein as being fully set forth. Any patent application to which this application claims priority is also incorporated by reference herein in the manner described above for publications and references.

1. An emulsification device comprising:
(a) a cylindrical outer part with two open ends;
(b) a cylindrical inner part with a bottom and having a circumference sufficient to allow the inner part to be nested within the outer part of the emulsification device, wherein the inner part and the outer part are capable of sliding freely;
(c) at least one groove on an interior surface of the outer part or on an exterior surface of the inner part, the groove having a height greater than a gap between the outer part and the inner part when nested;
(d) at least one hole in the inner part adjacent to the solid bottom;
(e) a radial distribution channel on the interior surface of the outer part or on the exterior surface of the inner part; and
(f) a radial nozzle channel at the base of the interior surface of the outer part or at the base of the exterior surface of the inner part.

2. The emulsification device of any one of claim 1, wherein the emulsification device is injection molded.

3. The emulsification device of claim 1, wherein the emulsification device is inserted into a container for use.

4. The emulsification device of claim 1, wherein the container is a polymerase chain reaction (PCR) tube.

5. The emulsification device of claim 1, wherein the container is a plate with a plurality of wells.

6. The emulsification device of claim 1, wherein the at least one groove is on the interior surface of the outer part.

7. The emulsification device of claim 1, wherein the at least one groove is on the exterior surface of the inner part.

8. The emulsification device of claim 1, wherein the at least one groove is closed off to form a channel when the inner part is nested within the outer part.

9. The emulsification device of claim 1, wherein the at least one groove is vertical while the device is in use.

10. The emulsification device of claim 1, wherein the at least one groove is horizontal while the device is in use.

11. The emulsification device of claim 1, wherein the at least one groove has a length of about 1 mm, a depth selected from the range of 0.01 mm to 0.5 mm, and a width selected from the range of 0.04 mm to 2 mm.

12. The emulsification device of claim 1, wherein the radius of the inner part and the radius of the outer part differ by less than the depth of the at least one groove.

13. The emulsification device of claim 1, wherein the radial distribution channel is about 0.5 mm above the bottom of the inner part.

14. The emulsification device of claim 1, wherein the radial distribution channel has a depth between about 10 μm and about 0.2 mm.

15. The emulsification device of claim 1, wherein the radial distribution channel is about 0.2 mm deep.

16. The emulsification device of claim 1, wherein the radial distribution channel has a depth of about 10 μm.

17. The emulsification device of claim 1, wherein the radial distribution channel has a depth of less than 10 μm.

18. The emulsification device of claim 1, wherein the radial nozzle channel is the same depth as the at least one groove.

19. The emulsification device of claim 1, wherein the at least one groove has a 20:1 ratio of length-to-depth.

20. The emulsification device of claim 1, wherein the bottom of the inner part is solid.

21. The emulsification device of claim 20, wherein the bottom of the inner part comprises a cup-shaped protrusion.

22. The emulsification device of claim 1, wherein the bottom of the inner part comprises a cone-shaped or a cylinder-shaped protrusion.

23. The emulsification device of claim 1, wherein the at least one hole is a slit.

24. A plurality of the emulsification device of claim 1 arranged in an array.

25. The plurality of claim 24, wherein the array is a plate with more than one well.

26. The plurality of claim 25, wherein the plate has at least 96 wells.
